(19) United States
(12) Patent Application Publication
(10) Pub. No.: US 2007/0224453 A1
(43) Pub. Date: Sep. 27, 2007

(54) Magnetic recording medium and magnetic recording apparatus

(75) Inventors: Ryosaku Inamura, Kawasaki (JP); Isatake Kaitsu, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/475,997

(22) Filed: Jun. 28, 2006

(30) Foreign Application Priority Data
Mar. 27, 2006 (JP) 2006-084450

(51) Int. Cl. G11B 5/66

(52) U.S. Cl. 428/827; 428/829; 428/830; 428/836.2; 428/836.3; 360/131

(57) ABSTRACT

According to the present invention, there is provided a magnetic recording medium 10 which includes: a non-magnetic base 1; a non-magnetic underlayer 3 formed on the non-magnetic base 1; a first recording layer 4 formed on the non-magnetic underlayer 3, the first recording layer 4 having a perpendicular magnetic anisotropy with an anisotropic magnetic field of Hₖ₁, a thickness of t₁, and a saturation magnetization of Ms₁; and a second recording layer 5 formed above or under the first recording layer 4, the second recording layer 5 having a perpendicular magnetic anisotropy with an anisotropic magnetic field of Hₖ₂, a thickness of t₂, and a saturation magnetization of Ms₂, wherein the anisotropic magnetic fields Hₖ₁ and Hₖ₂, the thicknesses t₁ and t₂, and the saturation magnetizations Ms₁ and Ms₂ satisfy Hₖ₂<Hₖ₁ and (t2·Ms₂)/(t₁ Ms₁)<1, respectively.

### CROSS-REFERENCE TO RELATED APPLICATIONS

This application is based on and claims priority of Japanese Patent Application No. 2006-084450 filed on Mar. 27, 2006, the entire contents of which are incorporated herein by reference.

### BACKGROUND OF THE INVENTION

1. Field of the Invention

The present invention relates to magnetic recording medium and magnetic recording apparatuses.

2. Description of the Related Art

In recent years, increase in the storage capacity has been remarkable in magnetic storage apparatuses such as a hard disk drive unit and the like, and the surface recording density of a magnetic recording medium incorporated into the apparatus has been steadily increasing. Those used as such a magnetic recording medium for many years include an in-plane recording medium, in which the direction of magnetization recorded in a recording layer is in an in-plane direction. However, in the in-plane magnetic recording medium, recording bits are prone to disappear due to a recording magnetic field and a thermal fluctuation, and therefore the densification of the surface recording density is coming to the limitation.

Then, as a medium in which recording bits are thermally more stable than the in-plane magnetic recording medium and densification is possible, a perpendicular magnetic recording medium, in which the direction of magnetization recorded in a recording layer is in a direction perpendicular to the medium, has been developed and is now put in practical use for some products.

In the perpendicular magnetic recording medium, as in the in-plane magnetic recording medium, an excellent thermal-fluctuation resistance is required so that the magnetization of a recording layer is not reversed due to heat, and low noise characteristic is also required.

In some techniques, which are used to achieve simultaneous pursuit of the thermal-fluctuation resistance and low noise characteristic, magnetic particles in a recording layer are far isolated from each other to enhance the coercivity. However, in this technique, the saturation magnetic field of the recording layer becomes larger than a recording magnetic field generated from the recording magnetic head, so that such a new problem arises that the writing capability of the recording layer degrades.

Therefore, the perpendicular magnetic recording medium needs to achieve simultaneous pursuit of the low noise characteristic, the thermal-fluctuation resistance, and the writing capability in a balanced manner.

Note that arts related to the present invention are disclosed in the following documents.

[Patent Document 1] Japanese Patent Laid-open Official Gazette No. 2001-148109

[Patent Document 2] Japanese Patent Laid-open Official Gazette No. 2001-101643

[Patent Document 3] Japanese Patent Laid-open Official Gazette No. Hei11-296833

[Patent Document 4] Japanese Patent Laid-open Official Gazette No. 2001-155321

[Patent Document 5] Japanese Patent Laid-open Official Gazette No. 2005-353256

[Non-Patent Document 1] Oikawa, T et al., “Microstructure and magnetic properties of CoPtCrSiO/Sub 2/perpendicular recording media,” IEEE Transactions on Magnetics, September 2002, Vol. 38, Pages 1976-1978

[Non-Patent Document 2] Ando, T. et al., “Triple-layer perpendicular recording media for high SN ratio and signal stability,” IEEE Transactions on Magnetics, September 1997, Vol. 33, Pages 2983-2985

[Non-Patent Document 3] Acharya, B. R. et al., “Anti-parallel coupled soft underlayers for high-density perpendicular recording”, IEEE Transactions on Magnetics, July 2004, Vol. 40, Pages 2383-2385;

[Non-Patent Document 4] Takenori, S. et al., “Exchange-coupled IrMn/CoZrNb soft underlayers for perpendicular recording media,” IEEE Transactions on Magnetics, September 2002, Vol. 38, Pages 1991-1993.

### SUMMARY OF THE INVENTION

According to one aspect of the present invention, there is provided a magnetic recording medium, comprising: a base member; an underlayer formed on the base member; a first recording layer formed on the underlayer, the first recording layer having a perpendicular magnetic anisotropy with an anisotropic magnetic field of Hₖ₁, a thickness of t₁, and a saturation magnetization of Ms₁; and a second recording layer formed above or under the first recording layer, the second recording layer being in contact with the first recording layer, and the second recording layer having a perpendicular magnetic anisotropy with an anisotropic magnetic field of Hₖ₂, a thickness of t₂, and a saturation magnetization of Ms₂, wherein the anisotropic magnetic fields Hₖ₁ and Hₖ₂, the thicknesses t₁ and t₂, and the saturation magnetizations Ms₁ and Ms₂ satisfy Hₖ₂<Hₖ₁ and (t₂·Ms₂)/(t₁·Ms₁)<1, respectively.

According to the present invention, the anisotropic magnetic fields Hₖ₁ and Hₖ₂ of the first and second recording layer satisfy Hₖ₂<Hₖ₁. Such characteristic is observed when the perpendicular magnetic anisotropy of the first recording layer is larger than that of the second recording layer.

The first recording layer thus has the large perpendicular magnetic anisotropy. Therefore, with the first recording layer alone, the magnetization of the first recording layer is difficult to be reversed by an external magnetic field, and it is thus difficult to write magnetic information. In view of this, the second recording layer is provided in contact with the first recording layer in the present invention. The second recording layer has weak perpendicular magnetic anisotropy, so that its magnetization is easily reversed by an external magnetic field. Therefore, when the magnetization of the second recording layer is reversed by the external magnetic field, magnetization of the first recording layer is also reversed by an interaction between spins of these recording layers, and hence it becomes easy to write magnetic information into the first recording layer.

Furthermore, because the perpendicular magnetic anisotropy of the first recording layer is large, directions of the magnetizations in each magnetic domain of the first recording layer are stabilized by the interaction between these magnetizations. Consequently, the direction of the magnetization, which bears magnetic information, is difficult to be reversed by heat. Thus, the thermal-fluctuation resistance of the first recording layer is enhanced.

Furthermore, in the present invention, the thicknesses t₁, t₂ and the saturation magnetizations Ms₁, Ms₂ of the first and second recording layers satisfy (t₂·Ms₂)/(t₁·Ms₁)<1. The investigation carried out by the present inventor revealed that by doing this way, an SN ratio in reading a high frequency signal written in the magnetic recording medium improves, and that lower noise is attained.

With these feature, the present invention can provide the magnetic recording medium that achieves simultaneous pursuit of the writing capability, the thermal-fluctuation resistance, and the low noise characteristic.

According to another aspect of the present invention, there is provided a magnetic recording apparatus, comprising: a magnetic recoding medium including: a base member; an underlayer formed on the base member; a first recording layer formed on the underlayer, the first recording layer having a perpendicular magnetic anisotropy with an anisotropic magnetic field of Hₖ₁, and a thickness of t₁, and a saturation magnetization of Ms₁; and second recording layer formed above or under the first recording layer, the second recording layer being in contact with the first recording layer, and the second recording layer having a perpendicular magnetic anisotropy with an anisotropic magnetic field of Hₖ₂, a thickness of t₂, and a saturation magnetization of Ms₂; and a magnetic head provided so as to face the magnetic recording medium, wherein the anisotropic magnetic fields Hₖ₁ and Hₖ₂, the thicknesses t₁ and t₂, and the saturation magnetizations Ms₁ and Ms₂ satisfy Hₖ₂<Hₖ₁ and (t₂·Ms₂)/(t₁·Ms₁)<1, respectively.

The magnetic recording apparatus of the present invention comprises the magnetic recording medium that can achieve simultaneous pursuit of the writing capability, the thermal-fluctuation resistance, and the low noise characteristic as described above. Therefore, the record reproducing characteristic of the magnetic recording apparatus becomes excellent.

### BRIEF DESCRIPTION OF THE DRAWINGS

FIG. 1A to 1D are cross sectional views in the course of manufacturing a magnetic recording medium concerning a first embodiment of the present invention.

FIG. 2 is a cross sectional view for explaining an operation of writing into the magnetic recording medium concerning the first embodiment of the present invention.

FIG. 3A is a magnetization curve of a first recording layer in the case where a second recording layer is not formed in the first embodiment of the present invention.

FIG. 3B is a magnetization curve of a third recording layer in the case where only the second recording layer is formed on a non-magnetic layer without forming the first recording layer.

FIG. 3C is a magnetization curve of a laminate layer of the first recording layer and second recording layer.

FIG. 4 is a graph obtained after investigating a relationship between a ratio of the products of the thicknesses and the saturation magnetizations of the first and second recording layers, (t₂·Ms₂)/(t₁·Ms₁), and a saturation magnetic field Hs of the laminate layer of these recording layers.

FIG. 5 is a graph obtained after investigating a relationship between a ratio of the products of the thicknesses and the saturation magnetizations of the first and second recording layers (t₂·Ms₂)/(t₁·Ms₁), and a writing capability of the laminate layer of these recording layers.

FIG. 6 is a graph obtained after investigating a relationship between a ratio of the products of the thicknesses and the saturation magnetizations of the first and second recording layers (t₂·Ms₂)/(t₁·Ms₁), and a coercive force Hc of the laminate layer of these recording layers.

FIG. 7 is a graph obtained after investigating a relationship between a coercive force Hc of a laminate layer of the first and second recording layers, and a recording bit width WCw.

FIG. 8 is a graph showing a relationship between the SN ratio when a low frequency signal recorded in the laminate layer of the first and second recording layers is read with a magnetic head, and the ratio (t₂·Ms₂)/(t₁·Ms₁).

FIG. 9 is a graph showing a relationship between the SN ratio when a high frequency signal recorded in the laminate layer of the first and second recording layers is read with a magnetic head, and the ratio (t₂·Ms₂)/(t₁·Ms₁).

FIG. 10 is a cross sectional view in the case where a sequence of forming the first recording layer and the second recording layer is reversed in the first embodiment of the present invention.

FIG. 11 is a plane view of a magnetic recording apparatus concerning a second embodiment of the present invention.

### DESCRIPTION OF THE PREFERRED EMBODIMENTS

### (1) First Embodiment

Next, while following the manufacturing process, a magnetic recording medium of the present embodiment is described in detail.

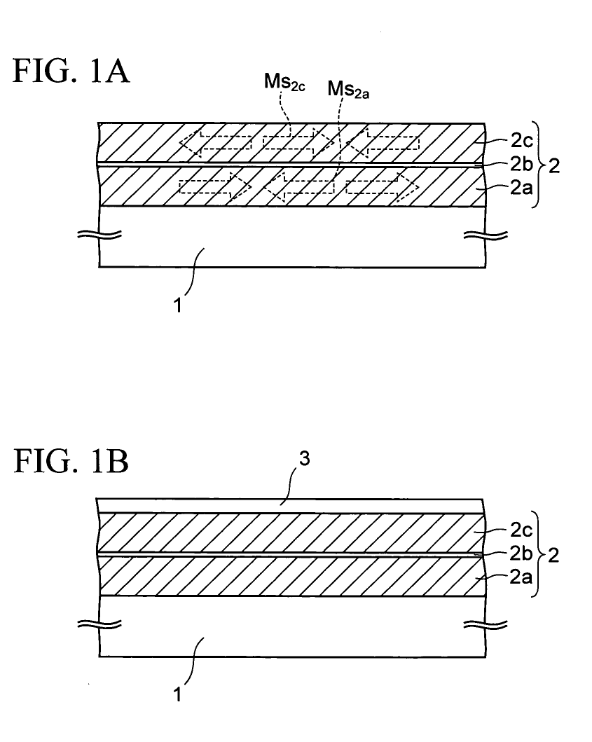

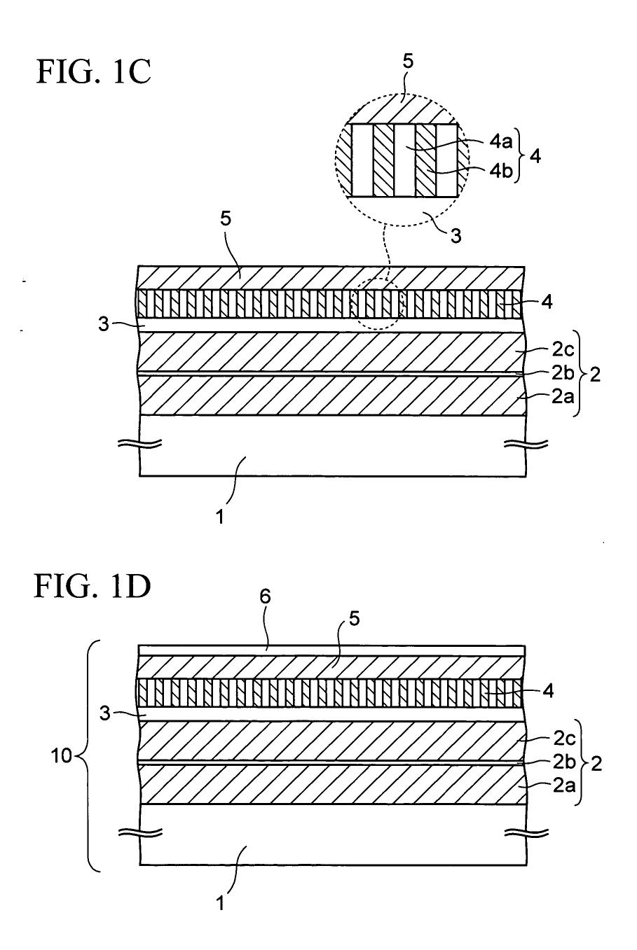

FIGS. 1A to 1D are cross sectional views in the course of manufacturing a magnetic recording medium according to the present embodiment.

First, the process until obtaining a cross sectional structure shown in FIG. 1A is described.

Firstly, CoNbZr layer is formed as a first soft magnetic layer 2a to a thickness of 25 nm on a non-magnetic base member 1 that is manufactured by applying an NiP plating to the surface of an Al alloy base member or a chemically strengthened glass base member. CoNbZr layer for the first soft magnetic layer 2a is an amorphous material, and is formed by a DC sputtering method with an input electric power of 1 kW in an Ar atmosphere of the pressure of 0.5 Pa.

Note that, as the non-magnetic base member 1, a crystallized glass, or a silicon substrate in which a thermal oxidation film is formed on the surface thereof, or a plastic substrate may be used. Furthermore, the first soft magnetic layer 2a is not limited to the CoNbZr layer. An alloy layer in an amorphous region or in a microcrystalline structure region, containing one or more elements of Co, Fe, and Ni, and one or more elements of Zr, Ta, C, Nb, Si, and B, may be formed as the first soft magnetic layer 2a. Such material includes, for example, CoNbTa, FeCoB, NiFeSiB, FeAlSi, FeTaC, FeHfC and the like.

Moreover, although a DC sputtering is used as the deposition method hereinafter unless otherwise be noted, the method for depositing film is not limited to the DC sputtering. An RF sputtering, a pulse DC sputtering, CVD, or the like can be employed as the deposition method.

Next, an Ru layer is formed as a non-magnetic layer 2b on the first soft magnetic layer 2a to the thickness of 0.7 nm by a DC sputtering with an input electric power of 150 W in an Ar atmosphere of 0.5 Pa pressure. The non-magnetic layer 2b is not limited to the Ru layer. The non-magnetic layer 2b may be composed only of any one of Ru, Rh, Ir, Cu, Cr, V, Re, Mo, Nb, W, Ta and C, or composed of an alloy containing at least one of these elements, or composed of MgO.

Subsequently, CoNbZr, which is an amorphous material, is deposited on the non-magnetic layer 2b as a second soft magnetic layer 2c to the thickness of 25 nm. The second soft magnetic layer 2c is not limited to the CoNbZr layer. Like the first soft magnetic layer 2a, an alloy layer in an amorphous region or in a microcrystalline structure region, containing one or more elements of Co, Fe, and Ni, and one or more elements of Zr, Ta, C, Nb, Si, and B, may be formed as the second soft magnetic layer 2c.

According to these steps, an underlying layer 2 consisting of the layers 2a to 2c is formed on the non-magnetic base member 1.

In the underlying layer 2, adjacent saturation magnetizations Ms₂ₐ and Ms_{2c} of the soft magnetic layers 2a and 2c respectively are stabilized in a mutually anti-parallel state, i.e., in the state where the soft magnetic layers 2a and 2c are anti-ferromagnetically coupled to each other. Such a state appears periodically as the thickness of the non-magnetic layer 2b increases, and it is preferable to form the non-magnetic layer 2c to the thinnest thickness under which the above state appears. Such thickness is about 0.7 to 1 nm, when the Ru layer is formed as the non-magnetic layer 2c.

Because the saturation magnetizations Ms₂ₐ and Ms_{2c} become mutually anti-parallel in this way, the magnetic fluxes originating from these magnetizations cancel to each other. Therefore, when there is no external magnetic field, a total magnetic moment of the underlying layer 2 becomes zero. Consequently, a magnetic leakage flux coming out of the underlying layer 2 is reduced, which in turn reduces spike noises resulting from the magnetic leakage flux.

Furthermore, in the case where a saturation magnetic flux density Bs of the underlying layer 2 is 1 T or more, a total thickness of the underlying layer 2 is set preferably to 10 nm or more, more preferably to 30 nm or more, from the viewpoint of the easiness of writing and reproducing by a magnetic head. However, because the manufacturing cost increases if the total film thickness of the underlying layer 2 is too thick, the total film thickness of the layer 2 is set preferably to 100 nm or less, more preferably to 60 nm or less.

Note that in place of the structure in which the first and second soft magnetic layers 2a and 2c are separated to each other by the non-magnetic layer 2b in this way, a single layer of an anti-ferromagnetic layer, in which the direction of magnetization is aligned to one direction as described in Non-Patent documents 2 and 3, may be formed as the underlying layer 2.

Next, as shown in FIG. 1B, a Ru layer is formed on the underlying layer 2 to the thickness of about 20 nm by a DC sputtering with an input electric power of 250 W in an Ar atmosphere of 8 Pa pressure, and this Ru layer is used as a non-magnetic underlayer 3.

It should be noted that the non-magnetic underlayer 3 is not limited to such single layer structure. The non-magnetic underlayer 3 may be formed from layers consisting of two layers or more. In this case, it is preferable that a Ru alloy layer containing any one of Co, Cr, Fe, Ni and Mn be formed as each of the layers.

Furthermore, the non-magnetic underlayer 3 may be formed after an amorphous seed layer is formed on the underlying layer 2 in order to improve the crystal orientation of the non-magnetic underlayer 3 and controlling the crystal grain diameter of the layer 3. In this case, it is preferable to form the seed layer composed any one of Ta, Ti, C, Mo, W, Re, Os, Hf, Mg and Pt, or of an alloy layer of these elements.

Next, the process until obtaining a cross sectional structure shown in FIG. 1C is described.

First, the base member 1 is placed in a sputter chamber in which a CoCrPt target and a SiO₂ target are prepared. Next, by introducing an Ar gas into the chamber as a sputtering gas and applying a DC power of 350 W to between the above-described targets and the base member 1, the sputtering of CoCrPt and SiO₂ is initiated.

According to such sputtering, a first recording layer 4 is formed on the non-magnetic underlayer 3. The first recording layer 4 has a granular structure, in which magnetic particles 4b made of CoCrPt are dispersed into a non-magnetic material 4a made of a silicon oxide (SiO₂). Although the film thickness of the first recording layer 4 is not limited, it is set to 12 nm in this embodiment.

The saturation magnetization Ms₁ of the first recording layer 4 formed under the aforementioned deposition conditions becomes 420 emu/cc.

Here, the non-magnetic underlayer 3 made of Ru under the first recording layer 4 has the crystal structure of hcp (hexagonal close-peaked), which functions to align the orientation of the magnetic particle 4b with the perpendicular direction of the in-plane direction. As a result, the magnetic particle 4b has a crystal structure of the hcp structure, which extends to the perpendicular direction like the non-magnetic underlayer 3. Moreover, the height direction (C axis) of a hexagonal pillar of the hcp structure becomes an axis of easy magnetization, and the first recording layer 4 thus exhibits a perpendicular magnetic anisotropy.

Note that although silicon oxide is employed as the non-magnetic material 4a, oxides other than the silicon oxide may be employed as the non-magnetic material 4a. Such an oxide includes, for example, an oxide of any one of Ta, Ti, Zr, Cr, Hf, Mg, and Al. Moreover, a nitride of any one of Si, Ta, Ti, Zr, Cr, Hf, Mg and Al may be used as the non-magnetic material 4b.

Furthermore, other material than CoCrPt, such as an alloy containing any one of Co, Ni and Fe may be employed as the material of the magnetic particle 4a.

Thereafter, a CoCrPtB layer is formed on the first recording layer 4 as a second recording layer 5 to the thickness of about 6 nm by a DC sputtering with an input electric power of 400 W in an Ar atmosphere. The second recording layer 5 has a perpendicular magnetic anisotropy, and the saturation magnetization Ms₂ thereof becomes 380 emu/cc. Note that, the second recording layer 5 is not limited to the CoCrPtB layer. A layer made of an alloy containing any one of Co, Ni and Fe may be formed as the second recording layer 5.

Then, as shown in FIG. 1D, a DLC (Diamond Like Carbon) layer is formed on the second recording layer 5 as a protective layer 6 to the thickness of about 4 nm by an RF-CVD (Radio Frequency Chemical Vapor Deposition) method using a C₂H₂ gas as the reactant gas. The deposition conditions of the protective layer 6 are, for example, a deposition pressure of about 4 Pa, a high frequency electric power of 1000 W, a bias voltage between the substrate to a shower head of 200 V, and a substrate temperature of 200° C.

Next, after applying lubricant (not shown) to the thickness of about 1 nm onto the protective layer 6, protrusions and foreign substances on the surface of the protective layer 6 are removed by using a polish tape.

In this way, a basic structure of a magnetic recording medium 10 of the present embodiment is completed.

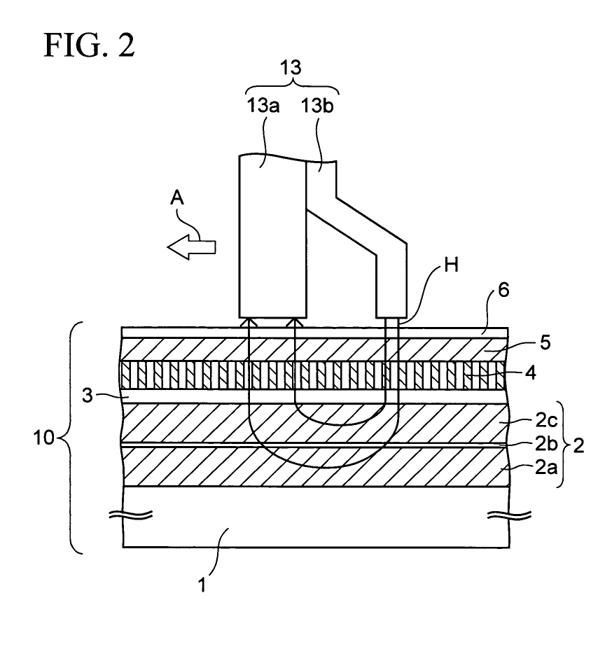

FIG. 2 is a cross sectional view for explaining an operation of writing to this magnetic recording medium 10.

In order to write to the medium 11, as shown in FIG. 2, a magnetic head 13 comprising a main pole 13b and a return yoke 13a is caused to face the magnetic recording medium 10. Then, a recording magnetic field H, which is generated at the main pole 13b of a small cross section and thus has a high flux density, is passed into the first and second recording layers 4 and 5. According to this, in a magnetic domain, which exists directly under the main pole 13b, of the first recording layer 4 having a perpendicular magnetic anisotropy, the magnetization is reversed by this recording magnetic field H and thus information is written.

After passing through the first recording layer 4 perpendicularly in this way, the recording magnetic field H runs in the in-plane direction of the underlying layer 2, which forms a magnetic flux circuit together with the magnetic head 13, and the recording magnetic field H passes through the first recording layer 4 again and is then fed back with a low flux density to the return yoke 13a of a large cross section. The underlying layer 2 plays the role to lead the recording magnetic field H into the film in this way and to cause the recording magnetic field H to pass through the first and second recording layers 4 and 5 perpendicularly.

Then, by changing the direction of the recording magnetic field H in response to recording signals while relatively moving the magnetic recording medium 10 and the magnetic head 13 in the A-direction of FIG. 2, a plurality of magnetic domains which are perpendicularly magnetized are formed in a truck direction of the recording medium 10, and thus the recording signals are recorded in the magnetic recording medium 10.

As described above, in this embodiment, the first recording layer 4 and the second recording layer 5 are stacked. Next, advantages obtained from the recording layer with such two-layered structure are described.

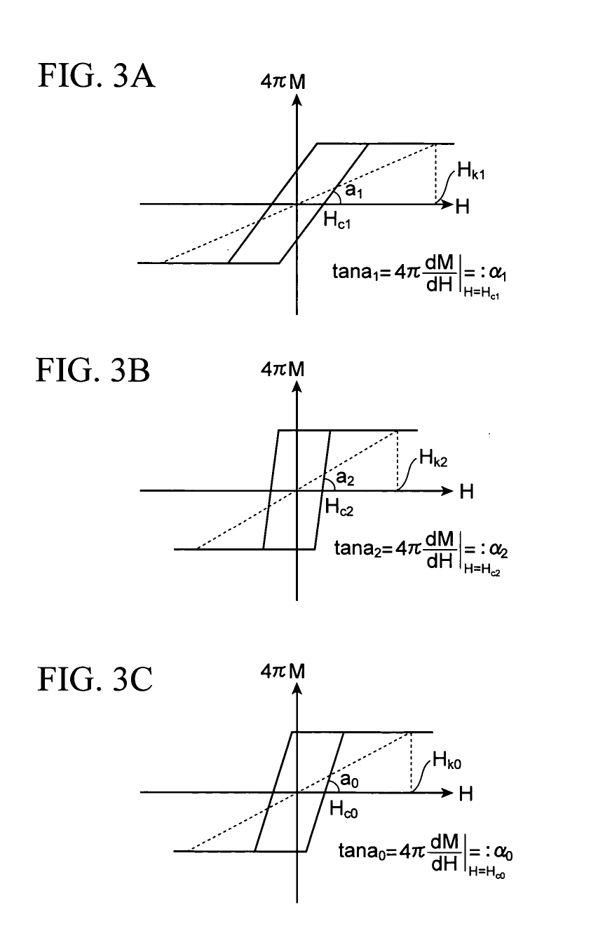

The solid curve in FIG. 3A is a magnetization curve when, in the case where the second recording layer 5 is not formed, a magnetic field is applied to the first recording layer 4. Note that the magnetic field directs to the direction of an axis of easy magnetization of the first recording layer 4. Furthermore, the horizontal axis represents the magnetic field H and the perpendicular axis represents the magnetization M. Moreover, in FIG. 3, the dotted curve is a magnetization curve when, in the above case, a magnetic field of the in-plane direction is applied to the first recording layer 4.

As previously described, the first recording layer 4 has the granular structure consisting of the non-magnetic material 4a and magnetic particle 4b. According to this structure, if the content of the non-magnetic material 4a in the main recording layer 4 is increased to widen the space between the magnetic particles 4b, then the interaction between the magnetic particles 4a becomes small, so that the magnetic anisotropy of the first recording layer 4 is enhanced. Therefore, even if an external magnetic field is applied to the first recording layer 4, the magnetization of the magnetic particle 4a is difficult to be reversed by the external magnetic field. Consequently, an angle a₁, which is formed between the magnetization curve and the horizontal axis, decreases and the anisotropic magnetic field Hₖ₁ increases.

Thus, the magnetic anisotropy can be expressed by the above-described angle a₁, and the anisotropic magnetic field Hₖ₁ in this way. As an index equivalent to the angle a₁, there is a gradient a₁ of the reversing portion of the magnetization curve. The gradient a₁, is also referred to as a “magnetization reversal parameter”, and is defined by the following Equation 1.

$${α}_{1} = 4 π \frac{ⅆ M}{ⅆ H} {\vert}_{H = {H}_{C1}} = tan {a}_{1} \qquad [ Equation 1 ]$$

Note that in Equation 1, Hc₁ denotes a coercivity which indicates a value of the magnetic field H at the intersection between the magnetization curve and the horizontal axis.

In the magnetic layer of the granular structure, as the space between the magnetic particles 4a becomes wider and the degree of isolation of each magnetic particle is enhanced further, the gradient a come close to its minimum value 1. On the contrary, as the above-described space becomes narrower and the interaction between magnetic particles becomes larger, a increases.

In the case where the second recording layer 5 is not formed, the gradient a₁, of the first recording layer 4 becomes such a small value as 1 to 2, and the anisotropic magnetic field Hₖ₁ becomes such a large value as 8-15 kOe.

On the other hand, FIG. 3B is a magnetization curve of the second recording layer 5 in the case where only the second recording layer 5 is formed on the non-magnetic underlayer 3 without forming the first recording layer 4. As in FIG. 3A, the solid curve is a magnetization curve when a magnetic field of the direction of an axis of easy magnetization (perpendicular direction) is applied to the second recording layer 5, and the dotted curve is a magnetization curve when a magnetic field is applied in the in-plane direction.

The CoCrPtB layer constituting the second recording layer 5 has a low magnetic anisotropy as compared with the first recording layer 4 having a granular structure. Therefore, a magnetization reversal parameter (gradient of the magnetization curve) a₂ of the second recording layer 5 becomes larger than the magnetization reversal parameter a₁, of the first recording layer 4, and has a value of 5 to 30. Moreover, an anisotropic magnetic field Hₖ₂ of the second recording layer 5 becomes 3 to 10 kOe, which is smaller than the anisotropic magnetic field Hₖ₁ of the first recording layer 4 alone.

On the other hand, FIG. 3C is a magnetization curve of the stacked layers consisting of the first recording layer 4 and the second recording layer 5 as the one shown in FIG. 1C. In FIG. 3C, as in FIGS. 3A and 3B, a magnetization curve when a magnetic field of the direction of an axis of easy magnetization is applied to the first recording layer 4 is shown by the solid curve, and a magnetization curve when a magnetic field of the in-plane direction is applied is shown by the dotted curve.

As shown in FIG. 3C, a gradient a₀ of the magnetization curve of the stacked first and second recording layers 4 and 5 has a middle value of the gradients a₁ and a₂ of each recording layers 4 and 5, and an anisotropic magnetic field Hₖ₀ also has a middle value of the above-described Hₖ₁ and Hₖ₂. The reason for this can be considered as follows. That is, when the first and second recording layers 4 and 5 are exposed to an external magnetic field, magnetizations of the second recording layer 5, which has small magnetic anisotropy and therefore easily responds to the external field, reverses. Influenced by this magnetization reversal, the magnetization of the first recording layer 4 also reverses, so that the magnetic anisotropy of the stacked layer consisting of the first and second recording layers 4 and 5 becomes smaller than the first recording layer 4 alone.

In this manner, the second recording layer 5 has the function to assist in reversing the magnetization of the first recording layer 4 that has a magnetic anisotropy larger than that of the second recording layer 5. Therefore, it is easier to reverse the magnetization of the first recording layer 4 as compared with the case where there is no second recording layer 5. Thus, it is easy in the present embodiment to write information into the first recording layer 4, without increasing the magnetic field of the magnetic head used for writing.

Furthermore, the first recording layer 4 itself has a large magnetic anisotropy as compared with the second recording layer 5, and the magnetizations in each magnetic domain of the layer 5 are coupled to each other strongly. Therefore, the direction of the magnetization of the first recording layer 4 is hard to reverse even if a heat is applied to it, so that the first recording layer 4 has an excellent thermal fluctuation resistance.

With these feature, a magnetic recording medium, which can achieve simultaneous pursuit of the writing capability and thermal-fluctuation resistance, can be provided in the present embodiment.

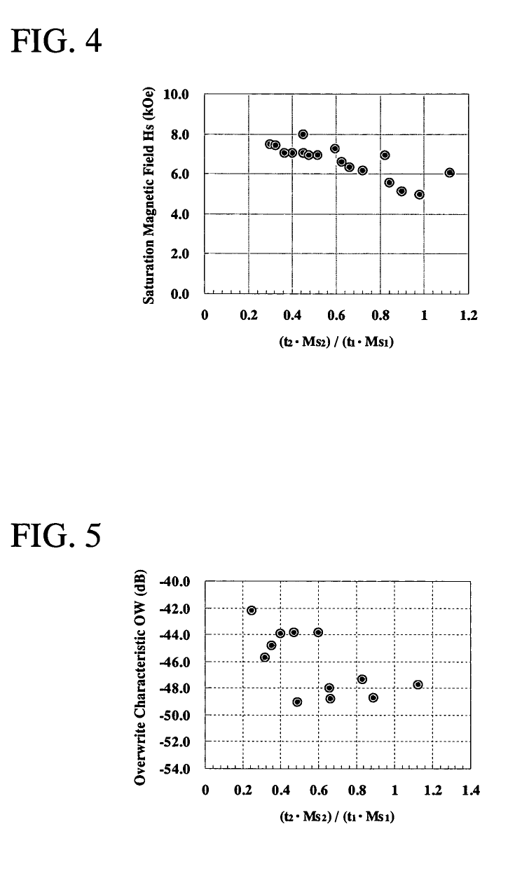

Next, the results obtained by investigating the characteristics of this magnetic recording medium 10 will be explained with reference to FIGS. 4 to 9.

In this investigation, a plurality of samples was prepared. In each samples, a product t₁·Ms₁ of the thickness t₁ and the saturation magnetization Ms₁of the first recording layer 4, and a product t₂·Ms₂ of the thickness t₂ and the saturation magnetization Ms₂ of the second recording layer 5 were varied. Then, following characteristics of each sample ware investigated.

FIG. 4 is a graph obtained by investigating a relationship between a ratio of the above-described products (t₂·Ms₂)/(t₁·Ms₁)and the saturation magnetic field Hₛ of the stacked recording layers 4 and 5.

As shown in FIG. 4, it was revealed that the saturation magnetic field Hs decreases as the ratio (t₂·Ms₂)/(t₁·Ms₁) becomes larger. Decrease in the saturation magnetic field Hs makes it easy to reverse the magnetizations of the recording layers 4 and 5 by the external magnetic field, and hence it is anticipated that the writing capability of the recording medium 10 will improve.

In order to confirm this, a relationship between the ratio (t₂·Ms₂)/(t₁·Ms₁) and a writing capability OW (overwrite characteristic) of the stacked recording layers 4 and 5 were investigated, and the result shown in shown in FIG. 5 was obtained.

As shown in FIG. 5, as the ratio (t₂·Ms₂)/(t₁·Ms₁) becomes larger, the absolute value of the writing capability increases, and thus the writing capability improved as anticipated.

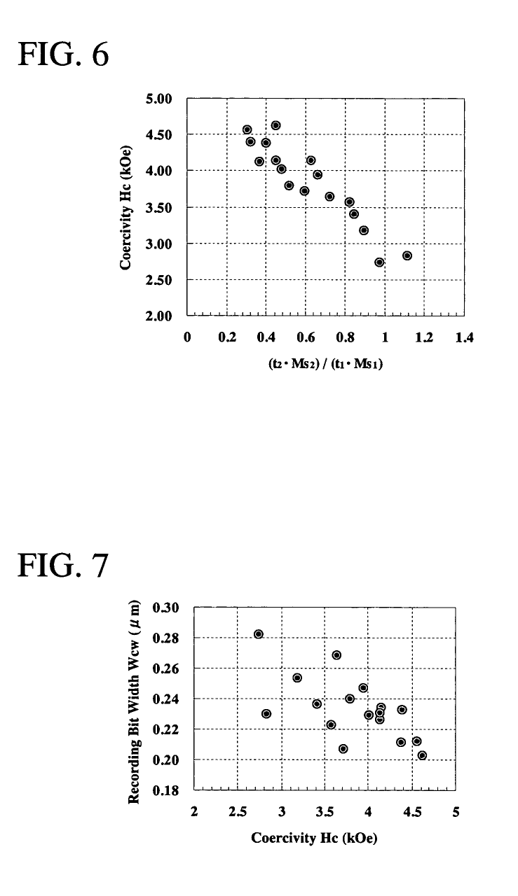

On the other hand, FIG. 6 is a graph obtained after investigating a relationship between the ratio (t₂·Ms₂)/(t₁·Ms₁) and the coercivity Hc of the stacked recording layers 4 and 5.

As shown in FIG. 6, the coercivity Hc decreases as the ratio (t₂·Ms₂)/(t₁·Ms₁) becomes larger.

FIG. 7 is a graph obtained by investigating a relationship between the coercivity Hc of the stacked recording layers 4 and 5, and the recording bit width WCw.

As shown in FIG. 7, as the coercivity Hc becomes smaller, the recording bit width WCw becomes wide. Therefore, in order to narrow the recording bit width WCw and improve the recording density, it is preferable that the ratio (t₂·MS₂)/(t₁·Ms₁) be decreased to increase the coercivity Hc, according to the result of FIG. 6.

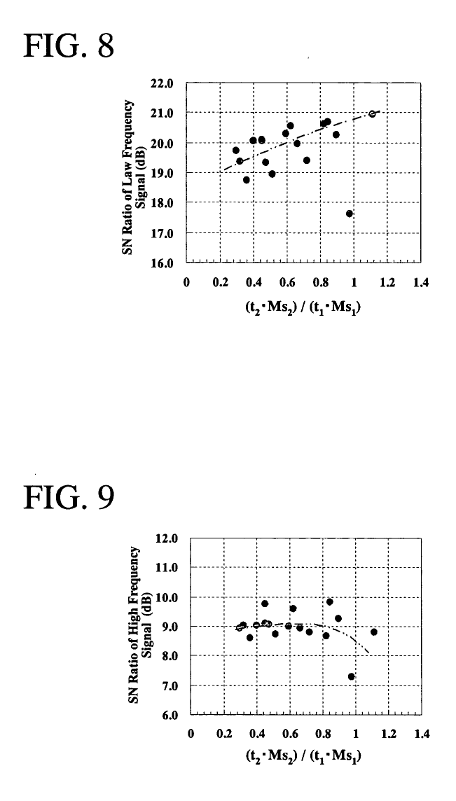

FIG. 8 is a graph showing a relationship between an SN ratio and the ratio (t₂·Ms₂)/(t₁·Ms₁) at the time when a low frequency signal recorded in the stacked first and second recording layers 4 and 5 is read with the magnetic head. Note that noises in the magnetic head and the circuitry are not included in this SN ratio. Moreover, as the low frequency signal, magnetic information with a linear recording density of 131 K FCI (Flux Change Per Inch) was written in the medium 10.

As shown in FIG. 8, as the above-described ratio (t₂·Ms₂)/(t₁·Ms₁) becomes larger, the SN ratio for the low frequency signal improves. As explained in FIGS. 4 and 5, improvement in the writing capability associated with the increase in the ratio (t₂·Ms₂)/(t₁·Ms₁) may be one contributing factor for this result.

On the other hand, FIG. 9 is a graph showing a relationship between an SN ratio and the ratio (t₂·Ms₂)/(t₁·Ms₁) at the time when a high frequency signal recorded in the stacked first and second recording layers 4 and 5 is read with the magnetic head. As in the case of the low frequency signal (FIG. 8), noises in the magnetic head and the circuitry are not included in this SN ratio. Moreover, as the high frequency signal, magnetic information with a linear recording density of 526 k FCl was written in the medium 10.

As shown in FIG. 9, the SN ratio for this high frequency signal has a peak, and the SN ratio degrades rapidly in a region where the ratio (t₂·Ms₂)/(t₁·Ms₁) is equal to or grater than 1. This is thought to be a result of the following fact. That is, if the ratio (t₂·Ms₂)/(t₁·Ms₁) increases, then the coercivity Hc decreases as shown in FIG. 6, and therefore, when the magnetization of a certain bit is reversed, then the magnetization of the adjacent bits are also reversed easily and thus the resolution of the recording medium 10 degrades.

Therefore, from the viewpoint of improving the SN ratio for the high frequency signal, it is preferable that the ratio (t₂·Ms₂)/(t₁·Ms₁) be set to less than one.

On the other hand, according to the result of FIG. 9, if the ratio (t₂·Ms₂)/(t₁·Ms₁) becomes smaller than 0.4, the SN ratio for the high frequency signal also degrades. This is thought to be a result of the fact that, as shown in FIG. 5, if the ratio (t₂·Ms₂)/(t₁·Ms₁) is small, the writing capability degrades.

Then, as shown in FIG. 9, in a region where the ratio (t₂·Ms₂)/(t₁·Ms₁) lies in a range between 0.4 and 0.8, the SN ratio for the high frequency signal has a relatively high value. Therefore, in order to improve the SN ratio more effectively, it is preferable that the ratio (t₂·Ms₂)/(t₁·Ms₁) be set to a range between 0.4 and 0.8, i.e., 0.4≦(t₂·Ms₂)/(t₁·Ms₁)≦0.8.

In this way, by setting the ratio (t₂·Ms₂)/(t₁·Ms₁) to less than 1.0, more preferably to a range of between 0.4 and 0.8, it is possible to realize lower noise of the medium 10, as well as the simultaneous achievement of the writing capability and the thermal-fluctuation resistance of the recording medium 10.

Moreover, by reducing the ratio (t₂·Ms₂)/(t₁·Ms₁) to less than 1.0, the coercivity Hc increase as shown in FIG. 6, and the recording bit width decrease as shown in FIG. 7. Therefore, it is made possible to provide the recording medium with a large storage capacity and a high recording density.

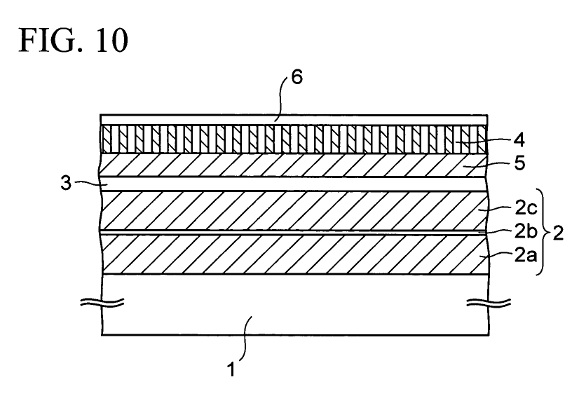

Note that, although the second recording layer 5 is formed on the first recording layer 4 as shown in FIG. 1D, the order of forming these recording layers is not limited thereto. For example, as shown in a cross sectional view of FIG. 10, the second recording layer 5 may be formed firstly, and the first recording layer 4 may be formed thereon. Even in this structure, it is possible to provide a magnetic recording medium which can achieve simultaneous pursuit of the writing capability, the thermal-fluctuation resistance, and the low noise characteristic.

### (2) Second Embodiment

In this embodiment, a magnetic recording apparatus provided with the magnetic recording medium 10 of the first embodiment is described.

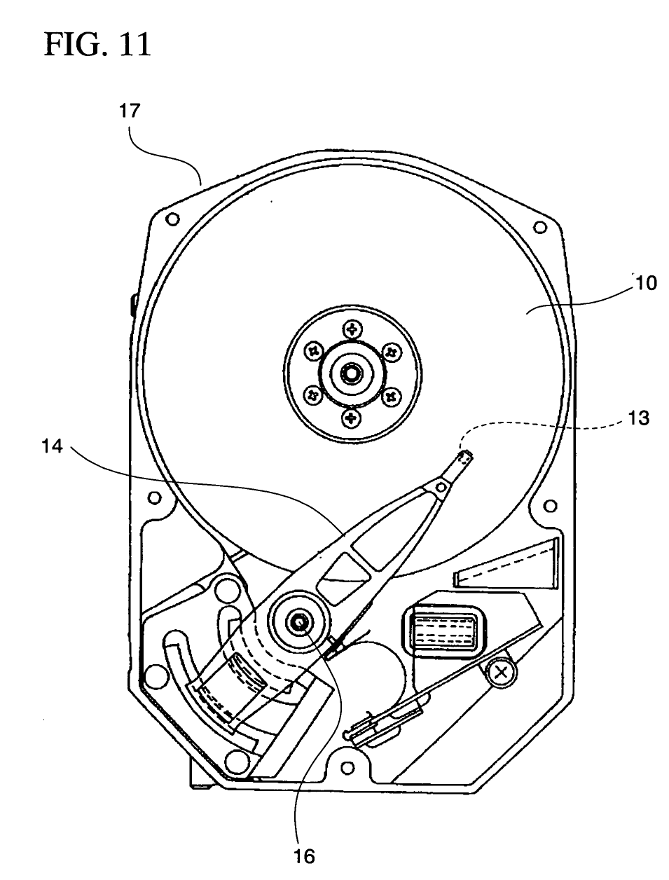

FIG. 11 is a plane view of the magnetic recording apparatus. This magnetic recording apparatus is a hard disk drive unit to be installed in a personal computer, or in a video-recording apparatus of a television.

In this magnetic recording apparatus, by means of a spindle motor or the like, the magnetic recording medium 10 is rotatably mounted in a housing 17 as a hard disk. Furthermore, a carriage arm 14 is provided in the housing 17, which is rotatable about an axis 16 by means of an actuator or the like. A magnetic head 13 is provided at the tip of the carriage arm 14. The magnetic head 13 scans the magnetic recording medium 10 from the above, thereby carrying out writing and reading of magnetic information to and from the magnetic recording medium 10.

It should be noted that the type of the magnetic head 13 is not limited. The magnetic head 13 may be composed of a magneto-resistive element, such as a GMR (Giant Magneto-Resistive) element and a TuMR (Tunneling Magneto-Resistive) element.

According to this embodiment, magnetic recording apparatuses having excellent record reproducing characteristics can be provided by the magnetic recording medium 10 which can achieve simultaneous pursuit of the writing capability, the thermal-fluctuation resistance, and the low noise characteristic as explained in the first embodiment.

Note that, the magnetic recording apparatus is not limited to the above-described hard disk unit, and may be a apparatus for recording magnetic information into a magnetic recording medium in the shape of a flexible tape.

As described above, according to the present invention, because the anisotropic magnetic fields Hₖ₁, Hₖ₂, the thicknesses t₁, t₂, and the saturation magnetizations Ms₁, Ms₂ of the first and second recording layers satisfy Hₖ₂<Hₖ₁ and (t₂·Ms₂)/(t₁·Ms₁)<1 respectively, it is possible to provide a magnetic recording medium which can achieve simultaneous pursuit of the writing capability, the thermal-fluctuation resistance, and the low noise characteristic, and to provide a magnetic recording apparatus comprising the same.

1. A magnetic recording medium, comprising:
a base member;
an underlayer formed on the base member;
a first recording layer formed on the underlayer, the first recording layer having a perpendicular magnetic anisotropy with an anisotropic magnetic field of Hₖ₁, a thickness of t₁, and a saturation magnetization of Ms₁; and
a second recording layer formed above or under the first recording layer, the second recording layer being in contact with the first recording layer, and the second recording layer having a perpendicular magnetic anisotropy with an anisotropic magnetic field of Hₖ₂, a thickness of t₂, and a saturation magnetization of Ms₂,
wherein the anisotropic magnetic fields Hk₁ and Hₖ₂, the thicknesses t₁ and t₂, and the saturation magnetizations Ms₁, and Ms₂ satisfy Hₖ₂<Hₖ₁ and (t₂·Ms₂)/(t_{1·Ms}₁) <1, respectively.

2. The magnetic recording medium according to claim 1, wherein the ratio (t₂·Ms₂)/(t₁·Ms₁) lies in a range of 0.4 to 0.8.

3. The magnetic recording medium according to claim 1, wherein a gradient α₁ of a reversing portion of a magnetization curve of the first recording layer and a gradient α₂ of a reversing portion of a magnetization curve of the second recording layer satisfy α₂>α₁.

4. The magnetic recording medium according to claim 1, wherein the first recording layer has a granular structure which is made by dispersing magnetic particles into a non-magnetic material.

5. The magnetic recording medium according to claim 4, wherein the magnetic particles are made of any one of Co, Ni and Fe, and the non-magnetic material is any one of an oxide and a nitride of any one of Si, Ta, Ti, Zr, Cr, Hf, Mg, and Al.

6. The magnetic recording medium according to claim 1, wherein the second recording layer is made of an alloy containing any one of Co, Ni and Fe.

7. The magnetic recording medium according to claim 1, wherein a first soft magnetic layer, a non-magnetic layer, and a second soft magnetic layer are formed above the base member in this order, and the underlayer is formed on the second soft magnetic layer.

8. A magnetic recording apparatus, comprising:
a magnetic recoding medium including: a base member; an underlayer formed on the base member; a first recording layer formed on the underlayer, the first recording layer having a perpendicular magnetic anisotropy with an anisotropic magnetic field of Hₖ₁, and a thickness of t₁, and a saturation magnetization of Ms₁; and second recording layer formed above or under the first recording layer, the second recording layer being in contact with the first recording layer, and the second recording layer having a perpendicular magnetic anisotropy with an anisotropic magnetic field of Hₖ₂, a thickness of t₂, and a saturation magnetization of Ms₂; and
a magnetic head provided so as to face the magnetic recording medium,
wherein the anisotropic magnetic fields Hₖ₁ and Hₖ₂, the thicknesses t₁ and t₂, and the saturation magnetizations Ms₁ and Ms₂ satisfy Hₖ₂<Hₖ₁ and (t₂·Ms₂)/(t₁·Ms₁)<1, respectively.

9. The magnetic recording apparatus according to claim 8, wherein the ratio (t₂·Ms₂)/(t₁·Ms₁) lies in a range of 0.4 to 0.8.

10. The magnetic recording apparatus according to claim 8, wherein a gradient α₁ of a reversing portion of a magnetization curve of the first recording layer and a gradient α₂ of a reversing portion of a magnetization curve of the second recording layer satisfy α₂>α₁.

11. The magnetic recording apparatus according to claim 8, wherein the first recording layer has a granular structure which is made by dispersing magnetic particles into a non-magnetic material.

12. The magnetic recording apparatus according to claim 8, wherein the magnetic particles are made of any one of Co, Ni and Fe, and the non-magnetic material is any one of an oxide and a nitride of any one of Si, Ta, Ti, Zr, Cr, Hf, Mg, and Al.

13. The magnetic recording apparatus according to claim 8, wherein the second recording layer is made of an alloy containing any one of Co, Ni and Fe.
